(19) United States
(12) Patent Application Publication
(10) Pub. No.: US 2010/0020580 A1
(43) Pub. Date: Jan. 28, 2010

(54) HIGH-VOLTAGE POWER SUPPLY

(75) Inventors: Dong-woo KIM, Seoul (KR); Jong-hwa CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/464,179

(22) Filed: May 12, 2009

(30) Foreign Application Priority Data
Jul. 24, 2008 (KR) 2008-72443

(51) Int. Cl. H02M 7/00

(52) U.S. Cl. 363/125

(57) ABSTRACT

A high-voltage power supply includes a first circuit which is realized on a first board, receives a first voltage, and generates a second voltage according to the first voltage, and a second circuit which is realized on a second board stacked on the first board and amplifies the second voltage and then rectifies the amplified second voltage.

### CROSS-REFERENCE TO RELATED APPLICATIONS

This application claims priority under 35 U.S.C. 119(a) from Korean Patent Application No. 10-2008-0072443, filed on Jul. 24, 2008, in the Korean Intellectual Property Office, the disclosure of which is incorporated herein in its entirety by reference.

### BACKGROUND

1. Field of the General Inventive Concept

The present general inventive concept relates to a power supply, and more particularly, to a high-voltage power supply which generates a high-voltage signal by using a low-voltage signal.

2. Description of the Related Art

An image forming apparatus, such as a laser beam printer (LBP) includes a plurality of devices that operate electronically. Examples of the plurality of devices included in the image forming apparatus include a device to charge a surface of a photoconductive drum, a device to form an electrostatic latent image on the surface of the photoconductive drum, and a device to transfer the electrostatic latent image onto a printing medium. Power sources for each of the plurality of devices may be different, and include a direct current (DC) high-voltage signal, such as DC 1000 V, equal to or above a predetermined voltage. However, an alternating current (AC) voltage, such as a home AC voltage of 220 Vrms, here, rms denotes root mean square, may be the power source for the image forming apparatus before being converted to a predetermined DC low-voltage signal, such as DC 5 V, and thus the image forming apparatus may include a high-voltage power supply that generates a plurality of high-voltage signals by receiving a low-voltage signal.

Such a high-voltage power supply may be realized in one single flat board including a circuit to generate a plurality of high-voltage signals by receiving one low-voltage signal. Here, contacts in and/or to the board, specifically contacts grounded to a contact to which a high-voltage signal is applied, can generate a spark between the contacts. Accordingly, it can be difficult to configure the contact on the boards and to reduce the size of the board, and thus difficulty may arise when applying a conventional high-voltage power supply to small home appliances. This is because the number of circuits arranged on the board of the high-voltage power supply increases as the number of high-voltage signals generated by using one low-voltage signal increases.

### SUMMARY

The present general inventive concept provides a high-voltage power supply having a small size, and an electronic device, such as an image forming apparatus, an electronic oven, an air cleaner, or a TV, for example, including the high-voltage power supply.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a high-voltage power supply including a first circuit which is realized on a first board and generates a second voltage according to a first voltage, and a second circuit which is realized on a second board stacked on the first board and amplifies the second voltage and then rectifies the amplified second voltage.

The second board may be prepared separately from the first board, and may be connected to the first board. An insulator may be disposed between the first and second boards. The second board and the second circuit may be covered with an insulator.

The second board and the second circuit may be prepared in a predetermined case including the insulator. The first circuit may be realized as one module on the first board, and the second circuit may be realized as one module on the second board.

The foregoing and/or other aspects and utilities of the present general inventive concept may also be achieved by providing an image forming apparatus including a high-voltage power supply, wherein the high-voltage power supply includes a first circuit which is realized on a first board and generates a second voltage according to a first voltage, and a second circuit which is realized on a second board stacked on the first board and amplifies the second voltage and then rectifies the amplified second voltage.

The second board may be prepared separately from the first board, and may be connected to the first board. An insulator may be disposed between the first and second boards. The second board and the second circuit may be covered with an insulator.

The second board and the second circuit may be prepared in a predetermined case including the insulator. The first circuit may be realized as one module on the first board, and the second circuit may be realized as one module on the second board.

The foregoing and/or other aspects and utilities of the present general inventive concept may also be achieved by providing an electronic device including a high-voltage power supply, wherein the high-voltage power supply includes a first circuit which is realized on a first board and generates a second voltage according to a first voltage, and a second circuit which is realized on a second board stacked on the first board and amplifies the second voltage and then rectifies the amplified second voltage.

The second board may be prepared separately from the first board, and may be connected to the first board. An insulator may be disposed between the first and second boards. The second board and the second circuit may be covered with an insulator.

The second board and the second circuit may be prepared in a predetermined case including the insulator. The first circuit may be realized as one module on the first board, and the second circuit may be realized as one module on the second board.

The foregoing and/or other aspects and utilities of the present general inventive concept may also be achieved by providing a high-voltage power supply including a low voltage input unit to input a first voltage and an oscillating circuit disposed on a first board to output a second voltage, and a high voltage generator to amplify a second voltage with a plurality of different gains and generates a plurality of DC high voltages by rectifying the amplified second voltages with different gains.

The foregoing and/or other aspects and utilities of the present general inventive concept may also be achieved by providing an image forming apparatus including a high-voltage power supply, wherein the high-voltage power supply includes a first circuit formed on a first board to receive a first voltage, a second circuit formed on a second board separate from the first board to receive a second voltage and amplify the second voltage with a plurality of different gains, wherein the high voltage generator may be disposed on a second board which is disposed over the first board, to be electrically connected to the first board.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a block diagram illustrating an image forming apparatus including a high-voltage power supply, according to an embodiment of the present general inventive concept;

FIG. 2 is a block diagram illustrating a high-voltage power supply according to an embodiment of the present general inventive concept;

FIGS. 3A and 3B are schematic diagrams illustrating a high-voltage power supply according to an embodiment of the present general inventive concept;

FIG. 4 is a schematic diagram illustrating a high-voltage power supply according to another embodiment of the present general inventive concept; and

FIG. 5 is a schematic diagram illustrating a high-voltage power supply according to another embodiment of the present general inventive concept.

### DETAILED DESCRIPTION OF THE EMBODIMENTS

Hereinafter, a high-voltage power supply according to embodiments of the present general inventive concept, and an electronic device, such as an image forming apparatus, including such a high-voltage power supply will be described more fully with reference to the accompanying drawings.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

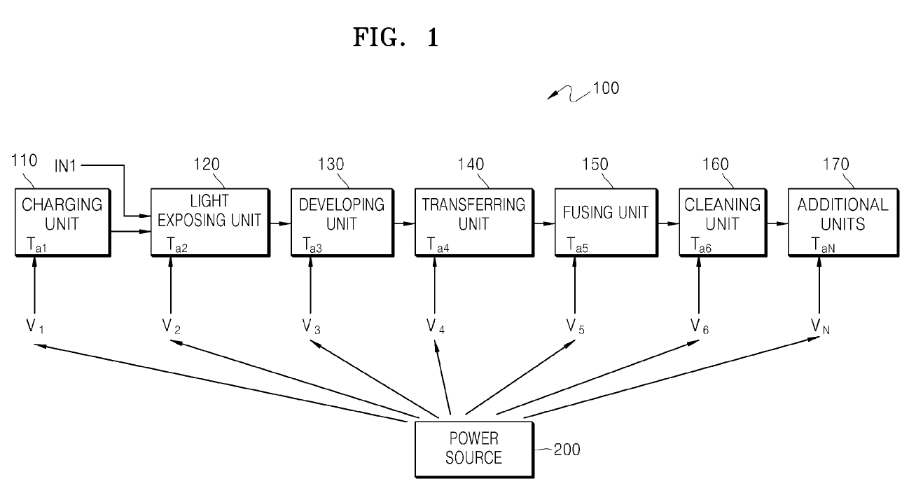

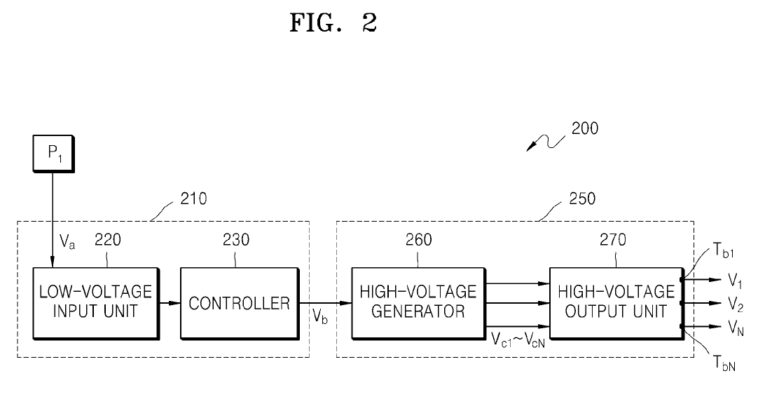

FIG. 1 is a block diagram illustrating an image forming apparatus 100 including a high-voltage power supply 200 (illustrated in FIG. 2), according to an embodiment of the present general inventive concept. Referring to FIG. 1, the image forming apparatus 100 includes a charging unit 110, a light exposing unit 120, a developing unit 130, a transferring unit 140, a fusing unit 150, a cleaning unit 160, and space for additional units 170 that may be included in the image forming apparatus 100. Each of the units illustrated in FIG. 1 includes at least one input terminal designated Ta1, Ta2, . . . TaN, depending on the number of units in the image forming apparatus 100. The input terminals Ta1, Ta2, . . . TaN each receive a power signal from high voltage power supply 200.

Here, the image forming apparatus denotes a device having a printing function, such as a multi-function peripheral (MFP) having a printing function. A single-color laser beam printer and a multi-color laser beam printer are examples of such an image forming apparatus.

The charging unit 110 may uniformly charge the entire surface of a photoconductive drum included in the image forming apparatus with a uniform polarity.

Then, the light exposing unit 120 may perform light exposure on the surface of the photoconductive drum in response to printing data received through an input terminal IN1 of the light exposing unit 120, thereby forming an electrostatic latent image corresponding to the printing data on the surface of the photoconductive drum. Here, the electrostatic latent image has a uniform polarity, such as +.

The developing unit 130 may generate a developed image by developing the electrostatic latent image formed on the surface of the photoconductive drum by using a developer, such as toner. Here, the developer has a uniform polarity, such as −.

The transferring unit 140 may transfer the developed electrostatic latent image formed on the surface of the photoconductive drum by the developing unit 130 onto a printing medium. Here, the printing medium denotes a medium on which the developed image is to be printed, and a material of the printing medium may vary, such as a paper or an overhead projector (OHP) film.

The fusing unit 150 fuses the developed electrostatic latent image transferred onto the printing medium by the transferring unit 140 onto the printing medium. In more detail, the fusing unit 150 fuses the developed electrostatic latent image onto the printing medium by using heat and pressure.

The cleaning unit 160 starts to operate after the operation of the transferring unit 140 is completed, and removes the leftover developer from the surface of the photoconductive drum. All of the developer on the surface of the photoconductive drum should be transferred to the printing medium, but some developer may be left on the surface of the photoconductive drum after a transferring operation. The developer left on the surface of the photoconductive drum after the operation of the transferring unit 140 is completed, with respect to an nth piece of printing data received through the input terminal IN1 (wherein n is a natural number), may deteriorate the printing quality of printed matter of an n+1th piece of printing data. Thus, the developer may be completely removed by the cleaning unit 160 before the light exposing unit 120 starts to operate for the n+1th piece of printing data.

Each of the charging unit 110, the light exposing unit 120, the developing unit 130, the transferring unit 140, the fusing unit 150, the cleaning unit 160, and the additional units 170 electronically operates by receiving power from the power source 200. Here, power from the power source applied to each of the charging unit 110, the light exposing unit 120, the developing unit 130, the transferring unit 140, the fusing unit 150, the cleaning unit 160, and the additional units 170 may be different values. The values may be direct current (DC) high-voltage signals equal to or above a uniform voltage, such as a DC 1000 V. The power voltages supplied from the power source 200 and received by the units 110, 120, . . . 170 may include V1, V2, V3, . . . Vn. As illustrated in FIG. 2, an alternating current (AC) voltage, such as a home AC voltage of 220 Vrms, may be converted to a predetermined DC low-voltage signal P₁, such as DC 5 V, which is supplied to the low-voltage input unit 220. Accordingly, the image forming apparatus of the present general inventive concept may include a high-voltage power supply that generates a plurality of high-voltage signals by receiving a low-voltage signal. A high-voltage power supply according to several embodiments of the present general inventive concept will now be described.

FIG. 2 is a block diagram illustrating a high-voltage power supply 200 according to an embodiment of the present general inventive concept. The high-voltage power supply 200 includes a first circuit 210 and a second circuit 250. The first circuit 210 includes a low-voltage input unit 220 and a controller 230, and the second circuit includes a high-voltage generator 260 and a high-voltage output unit 270. The low-voltage input unit 220 receives a low-voltage signal Vₐ converted from an external power source.

The controller 230 generates a second voltage Vb according to the received first voltage. Here, the first voltage denotes the DC low-voltage signal transmitted to the image forming apparatus, such as DC 5 V, and the second voltage denotes the AC low-voltage determined according to the first voltage, such as DC 18 Vrms. Here, a relationship between the first and second voltages is predetermined. The controller 230 may include an oscillating circuit.

The high-voltage generator 260 amplifies the second voltage with a predetermined gain, and rectifies the amplified second voltage. Here, the rectified second voltage results in at least one DC high-voltage signal, i.e., a DC voltage equal to or above a predetermined voltage, such as 800 V. Since the rectified second voltage may include an alternating component (vibration), the high-voltage generator 260 may include an electrolyte condenser that flattens the rectified second voltage. However in the following embodiments, it is assumed that the high-voltage generator 260 does not include the electrolyte condenser for convenience of description.

The high-voltage generator 260 may amplify the second voltage with a plurality of different gains, and generate a plurality of DC high-voltages Vc1-Vcn by rectifying the amplified second voltages with different gains. The plurality of DC high-voltage signals Vc1-Vcn may be power sources for each of a plurality of devices that electronically operate in the image forming apparatus 100. For example, the high-voltage generator 260 may amplify the second voltage, such as 18 Vrms, with a plurality of different gains, and generate a DC high-voltage signal of −300 V, a DC high-voltage signal of −1200 V, and a DC high-voltage signal of +1300 V by rectifying the amplified second voltages with different gains. The high voltage generator 260 may generate as many high voltage signals as there are components in the image forming apparatus 100. For example, the DC high-voltage signal of −1200 V may be supplied to the charging unit 110 of FIG. 1 as the power source V1 of the charging unit 110, the DC high-voltage signal of −300 V may be supplied to the developing unit 130 of FIG. 1 as the power source V3 of the developing unit 130, and the DC high-voltage signal of +1300 V may be supplied to the transferring unit 140 of FIG. 1 as the power source V4 of the transferring unit 140.

The high-voltage output unit 270 outputs the plurality of high-voltage signals V1, V2, . . . VN generated by the high-voltage generator 260 via a plurality of output terminals Tb1, Tb2, . . . TbN.

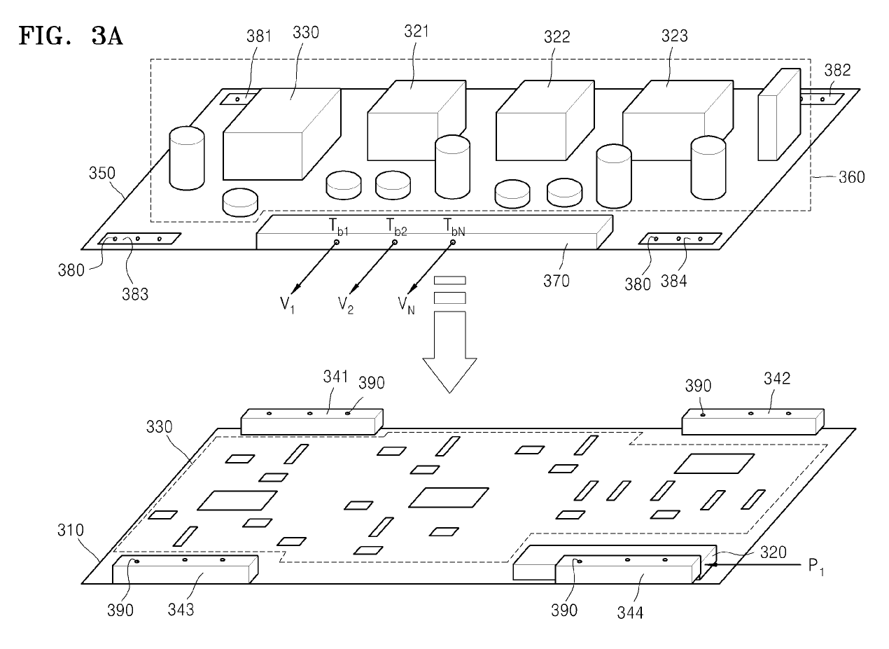

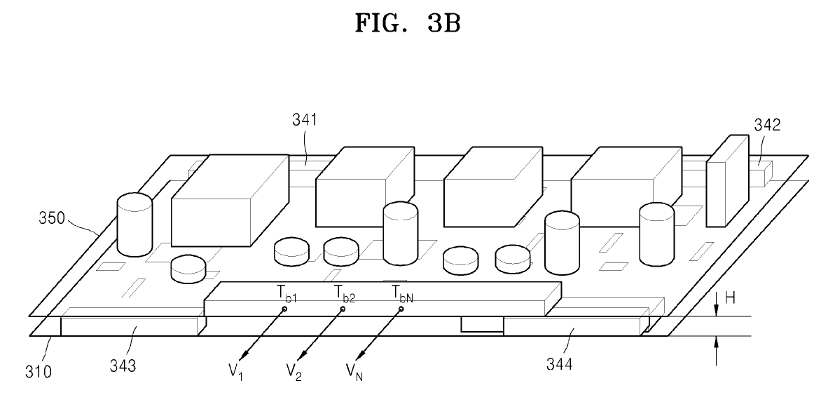

The first circuit 210 and the second circuit 250 may be prepared on different boards as will be illustrated in FIGS. 3A, 3B, 4 and 5 below. The first circuit 210 is realized on a pre-prepared first board and the second circuit 250 is realized on a pre-prepared second board.

The second board is a separate board from the first board and is electrically connected to the first board. The second board may be stacked on the first board. Accordingly, an output signal Vb of the first circuit 210 is input to the second circuit 250 on the second board.

The first board may have a size that can at least include the first circuit 210, and the second board may have a size that can at least include the second circuit 250.

The first circuit 210 may be realized as one module, for example, an integrated chip, on the first board, and the second circuit 250 may be realized as one module on the second board.

FIGS. 3A and 3B are schematic diagrams illustrating a high-voltage power supply according to an embodiment of the present general inventive concept.

According to the current embodiment, the high-voltage power supply may not include an insulator. However, the present general inventive concept is not limited thereto.

A first circuit is formed on a first board 310, and a second circuit is formed on a second board 350. Here, the first circuit includes a low-voltage input unit 320 and a controller 330, and the second circuit includes a high-voltage generator 360 and a high-voltage output unit 370. The high voltage generator 360 may include a plurality of amplifier circuits 321, 322 and 323, for example. The plurality of amplifier circuits may be configured to each produce a different gain, or each of the plurality of amplifiers may be a variable-gain amplifier that may be configured to output a plurality of different voltages with different gains. The second board 350 is displayed for exemplary purposes and may include more or less amplifier circuits than illustrated. The high voltage generator 360 may include one or more rectifier circuits 330 to rectify the voltages outputted from the amplifier circuits.

The second board 350 is stacked on the first board 310 by being connected to the first board 310 in a direction of an arrow illustrated in FIG. 3A. Accordingly, the high-voltage power supply illustrated in FIG. 3B is obtained. The first board 310 is connected to the second board 350 via various connectors 341, 342, 343, and 344, on the first board 310 as illustrated in FIG. 3A. The second board 350 includes connectors 381, 382, 383, and 384 to correspond to the connectors on the first board 310. Within the connectors 341-344 and 381-384 are a plurality of node electrodes 380, 390 to specifically direct control signals and power signals from the first board 310 to the second board 350. The node electrodes between the two boards may be connected by wires, solder bumps, solder balls, or other methods or devices for connecting circuit boards, as are known in the art.

In operation, the low-voltage input unit 320 receives the low-voltage DC power signal P1. The low-voltage DC signal is transmitted to the controller 330, which includes an oscillating circuit to change the DC power signal into an AC Vrms signal. The controller 330 may output control signals through connectors 343 and 344 to control the operation of the second board 350 and the high voltage power supply as a whole, and may output the AC Vrms signal through connectors 341 and 342 to the second board 350. The AC Vrms signal may be directed through the amplifier circuits 320, 321, 322 to the rectifier circuit 330, and the amplified, rectified signals V1, V2, . . . Vn are directed through output terminals Tb1, Tb2, . . . Tbn to the input terminals Ta1, Ta2, . . . Tan of the corresponding units of the image forming apparatus 100. The number of components in the image forming apparatus 100 will determine the number of “N” rectified signals to be output through the Tb terminals.

FIG. 3B is a schematic diagram of the high voltage power supply when the second board 350 is connected to the first board 310. The size of the high voltage power supply illustrated in FIG. 3B may be determined by a height “H” of the connectors, 341, 342, 343, and 344.

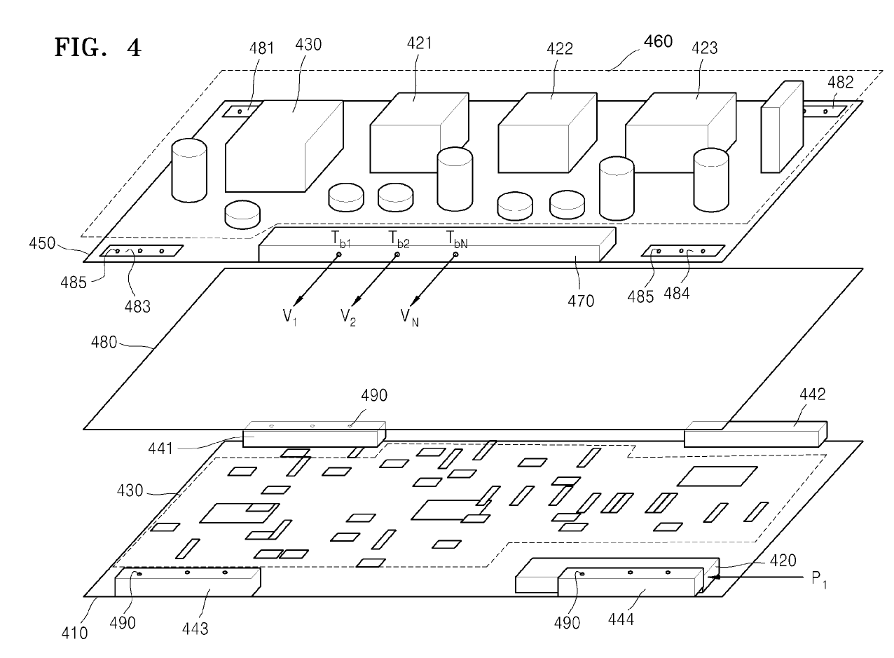

FIG. 4 is a schematic diagram illustrating a high-voltage power supply according to another embodiment of the present general inventive concept.

According to the current embodiment, an insulator 480 is disposed between a first board 410 and a second board 450. Accordingly, a spark is prevented from being generated between contacts of the first or second board 410 or 450, specifically between contacts grounded with a contact to which a high-voltage signal is applied, from among the contacts of the second board 450. The thickness of the insulator 480 does not significantly add to the height “H” of the connectors and the overall high voltage power supply.

In detail, a first circuit is formed on the first board 410 and a second circuit is formed on the second board 450. Here, the first circuit includes a low-voltage input unit 420 and a controller 430, and the second circuit includes a high-voltage generator 460 and a high-voltage output unit 470. The high voltage generator 460 may include a plurality of amplifier circuits 421, 422 and 423, for example. The plurality of amplifier circuits may be configured to each produce a different gain, or each of the plurality of amplifiers may be a variable-gain amplifier that may be configured to output a plurality of different voltages with different gains. The second board 450 is displayed for exemplary purposes and may include more or less amplifier circuits than illustrated. The high voltage generator 460 may include one or more rectifier circuits 430 to rectify the voltages outputted from the amplifier circuits.

The second board 450 is connected to the first board 410 via a plurality of connectors 441 through 444. The second board 450 includes connectors 481, 482, 483, and 484 to correspond to the connectors on the first board 410. Within the connectors 441-444 and 481-484 are a plurality of node electrodes 485, 490 to specifically direct control signals and power signals from the first board 410 to the second board 450. The node electrodes between the two boards may be connected by wires, solder bumps, solder balls, or other methods or devices for connecting circuit boards, as are known in the art. Since the insulator 480 is disposed between the first and second boards 410 and 450, the first board 410, the insulator 480, and the second board 450 are sequentially stacked in order, and thus the high-voltage power supply illustrated in FIG. 4 is obtained. The circuit board configuration illustrated in FIG. 4 operates in a similar manner to the configuration illustrated in FIG. 3A, except for the placement of the insulator 480 described herein.

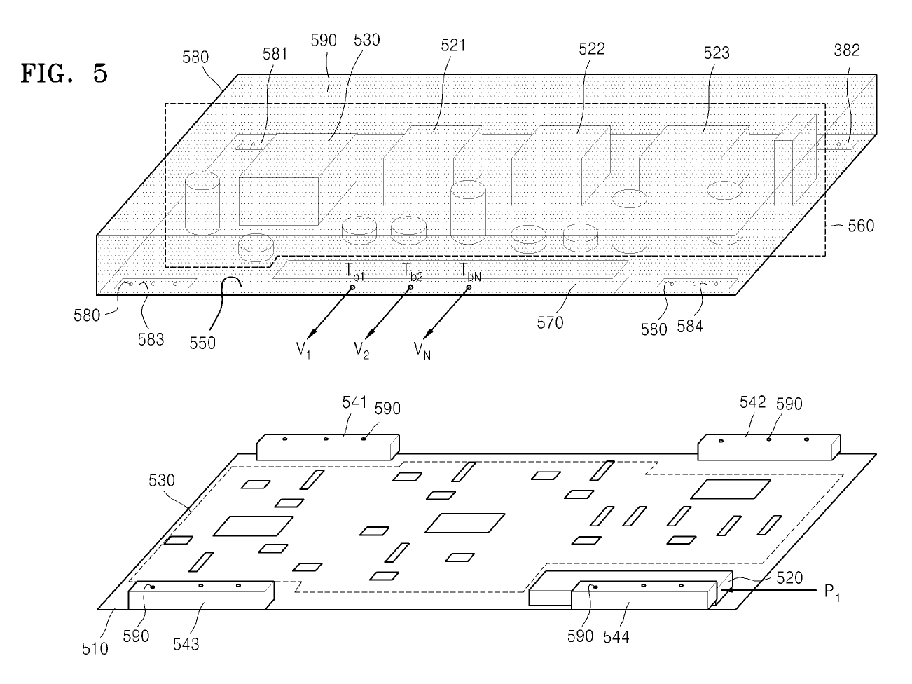

FIG. 5 is a schematic diagram illustrating a high-voltage power supply according to another embodiment of the present general inventive concept.

According to the current embodiment, a second board 550 including a second circuit are covered with an insulator 590. In detail, the second board 550 and the second circuit are prepared in a case 580, and a space of the case 580 excluding the second board 550 and the second circuit is filled with the insulator 590. Accordingly, a spark is prevented from being generated between contacts of the second board 550, specifically between contacts grounded with a contact to which a high-voltage signal is applied.

A first circuit is formed on the first board 510 and a second circuit is formed on the second board 550. The first circuit includes a low-voltage input unit 520 and a controller 530, and the second circuit includes a high-voltage generator 560 and a high-voltage output unit 570. The high voltage generator 560 may include a plurality of amplifier circuits 521, 522 and 523, for example. The plurality of amplifier circuits may be configured to each produce a different gain, or each of the plurality of amplifiers may be a variable-gain amplifier that may be configured to output a plurality of different voltages with different gains. The second board 550 is displayed for exemplary purposes and may include more or less amplifier circuits than illustrated. The high voltage generator 560 may include one or more rectifier circuits 530 to rectify the voltages outputted from the amplifier circuits.

The second board 550 is stacked on the first board 510 by being connected to the first board 510 via a plurality of connectors 541 through 544, and the second board 550 includes connectors 581, 582, 583, and 584 to correspond to the connectors on the first board 510. Within the connectors 541-544 and 581-584 are a plurality of node electrodes 580, 590 to specifically direct control signals and power signals from the first board 510 to the second board 550. The node electrodes between the two boards may be connected by wires, solder bumps, solder balls, or other methods or devices for connecting circuit boards, as are known in the art thus the high-voltage power supply illustrated in FIG. 5 is obtained. The circuit board configuration illustrated in FIG. 5 operates in a similar manner to the configuration illustrated in FIGS. 3A and 4, described herein.

In the high-voltage power supply according to the embodiments of the present general inventive concept, a first circuit, which receives a first voltage (a DC low-voltage signal) and generates a second voltage (an AC low-voltage signal) according to the first voltage, and a second circuit, which amplifies the second voltage with a predetermined gain, are formed on different boards instead of the same board, and the boards are stacked and connected to each other. Accordingly, the size of the high-voltage power supply can be minimized, and moreover, an electronic device, such as an image forming apparatus, an electronic oven, an air cleaner, or a TV, including the high-voltage power supply that may generate several high voltage outputs can be minimized, or made smaller.

While the present general inventive concept has been particularly illustrated and described with reference to preferred embodiments thereof, it will be understood by those of ordinary skill in the art that various changes in form and details may be made therein without departing from the spirit and scope of the present general inventive concept as defined by the appended claims. The embodiments should be considered in descriptive sense only and not for purposes of limitation. Therefore, the scope of the present general inventive concept is defined not by the detailed description of the present general inventive concept but by the appended claims, and all differences within the scope will be construed as being included in the present general inventive concept.

What is claimed is:

1. A high-voltage power supply comprising:
a first circuit which is realized on a first board and generates a second voltage according to a first voltage; and
a second circuit which is realized on a second board stacked on the first board and amplifies the second voltage and then rectifies the amplified second voltage.

2. The high-voltage power supply of claim 1, wherein the second board is prepared separately from the first board, and is connected to the first board.

3. The high-voltage power supply of claim 1, wherein an insulator is disposed between the first and second boards.

4. The high-voltage power supply of claim 1, wherein the second board and the second circuit are covered with an insulator.

5. The high-voltage power supply of claim 4, wherein the second board and the second circuit are prepared in a predetermined case including the insulator.

6. The high-voltage power supply of claim 1, wherein the first circuit is realized as one module on the first board, and the second circuit is realized as one module on the second board.

7. An image forming apparatus comprising a high-voltage power supply, wherein the high-voltage power supply comprises:
a first circuit which is realized on a first board and generates a second voltage according to a first voltage; and
a second circuit which is realized on a second board stacked on the first board and amplifies the second voltage and then rectifies the amplified second voltage.

8. The image forming apparatus of claim 7, wherein the second board is prepared separately from the first board, and is connected to the first board.

9. The image forming apparatus of claim 7, wherein an insulator is disposed between the first and second boards.

10. The image forming apparatus of claim 7, wherein the second board and the second circuit are covered with an insulator.

11. The image forming apparatus of claim 10, wherein the second board and the second circuit are prepared in a predetermined case including the insulator.

12. The image forming apparatus of claim 7, wherein the first circuit is realized as one module on the first board, and the second circuit is realized as one module on the second board.

13. An electronic device comprising a high-voltage power supply, wherein the high-voltage power supply comprises:
a first circuit which is realized on a first board and generates a second voltage according to a first voltage; and
a second circuit which is realized on a second board stacked on the first board and amplifies the second voltage and then rectifies the amplified second voltage.

14. The electronic device of claim 13, wherein the second board is prepared separately from the first board, and is connected to the first board.

15. The electronic device of claim 13, wherein an insulator is disposed between the first and second boards.

16. The electronic device of claim 13, wherein the second board and the second circuit are covered with an insulator.

17. The electronic device of claim 16, wherein the second board and the second circuit are prepared in a predetermined case including the insulator.

18. The electronic device of claim 13, wherein the first circuit is realized as one module on the first board, and the second circuit is realized as one module on the second board.

19. A high-voltage power supply comprising:
a low voltage input unit to input a first voltage and an oscillating circuit disposed on a first board to output a second voltage; and
a high voltage generator to amplify a second voltage with a plurality of different gains and generates a plurality of DC high voltages by rectifying the amplified second voltages with different gains,
wherein the high voltage generator is disposed on a second board disposed over the first board to be electrically connected to the first board.
